(19) United States
(12) Patent Application Publication
(10) Pub. No.: US 2014/0263194 A1
(43) Pub. Date: Sep. 18, 2014

(54) CORED NON-ARC CONSUMABLE FOR JOINING OR OVERLAYING AND SYSTEMS AND METHODS FOR USING CORED NON-ARC CONSUMABLES

(71) Applicant: LINCOLN GLOBAL, INC., City of Industry, CA (US)

(72) Inventors: Badri K. NARAYANAN, Mayfield Heights, OH (US); Jonathan S. Ogborn, Concord Twp., OH (US); Michael Whitehead, Strongville, OH (US); Rajan B. Vaidyanath, Mentor, OH (US)

(73) Assignee: Lincoln Global, Inc., City of Industry, CA (US)

(21) Appl. No.: 13/839,432

(22) Filed: Mar. 15, 2013

(51) Int. Cl. B23K 35/22; B23K 9/04

(52) U.S. Cl. CPC B23K 35/22; B23K 9/042
USPC 219/76.1; 219/146.1

(57) ABSTRACT

Embodiments of the invention relate to consumables that are used with non-arc deposition processes, including hot-wire deposition processes. Exemplary embodiments of the present invention eliminate the use of arc initiators or arc stabilizers in the consumable. Other embodiments add additional amounts of carbonates in the consumable than would otherwise be present in consumables for arc welding processes. Similarly, other exemplary embodiments of the present invention include additional amounts of nitrides than would otherwise be present in arc process consumables. Other exemplary embodiments include carbides that are desired to be deposited through the non-arc processes.

### TECHNICAL FIELD

This invention relates to consumables to be used in a non-arc based joining or overlaying operation. More specifically, the subject invention relates to cored consumables that are used in non-arc joining and overlaying operations having chemical compositions consistent with not having to use an arc for consumable transfer.

### BACKGROUND

With the development of hot-wire joining and overlaying applications, particularly by The Lincoln Electric Company of Cleveland, Ohio, the process is becoming more and more efficient and can be used more many different applications. However, many times the process employs known consumables which were originally developed for deposition processes which use an arc. While these consumables are often acceptable, they can include materials that are not desirable but are needed for an arc process, or they exclude materials that would otherwise be desirable but do not transfer well through an arc transfer process. Therefore, it is desirable to have consumables that are specifically developed for non-arc transfer processes.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention relate to consumables that are used with non-arc deposition processes, including hot-wire deposition processes. Some exemplary embodiments of the present invention eliminate the use of arc initiators or arc stabilizers in the consumable. Other exemplary embodiments of the present invention add additional amounts of carbonates in the consumable than would otherwise be present in consumables for arc welding processes. Similarly, other exemplary embodiments of the present invention include additional amounts of nitrides than would otherwise be present in arc process consumables. Other exemplary embodiments of the present invention, include carbides that are desired to be deposited through the non-arc processes.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIGS. 1A-1B are exemplary illustrations of cored consumables in accordance with embodiments of the present invention; and

FIG. 2 illustrates a functional schematic block diagram of an exemplary embodiment of a combination wire feeder and energy source system for any of cladding, building up, filling, and hard-facing overlaying applications.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

Embodiments of the present invention are directed to cored consumables which are specifically used in non-arc deposition processes, for example hot-wire processes. The cored consumables can either be metal-cored or flux-cored. Exemplary embodiments are shown in FIGS. 1A (metal core) and 1B (flux-core). It should be understood that although the term “flux-core” is used this should not be understood to include traditional flux as used in arc welding operations. Since the consumables of the present invention are used in a non-arc process there is no need for traditional “flux.” The terminology “flux-core” as used herein is intended to signify a core of granular material (which can include metallic and non-metallic particles, although the inclusion of non-metallic is not necessary in various embodiments), as contrasted with a metal core as shown in FIG. 1A. In each embodiment, a sheath 1010/1110 surrounds the core 1030/1130. The general construction and manufacture of cored consumables is known and need not be described in detail herein. Exemplary embodiments of the cored-consumables described herein are not limited to either joining or overlaying processes.

It should be noted that the consumables discussed and described herein are cored consumables used for joining, welding and/or overlaying, cladding operations, and the consumables described herein are not brazing consumables.

As is generally understood an arc transfer process (whether for joining or overlaying) utilizes a high heat arc plasma to transfer the consumable to a molten puddle. As such, traditional arc process consumables contain various elements and compounds which are needed to aid in arc ignition and maintain arc stability. Furthermore, in traditional arc process consumables various elements and compounds are avoided altogether or are used only very sparingly as they interact poorly with the arc and/or do not transfer well through the arc. For example, these materials are often carbonates, nitrides, carbides and elemental carbons. In other applications, other metallic elements are also used sparingly, or not at all, in arc based consumables. These elements can include copper, magnesium, and rare earth elements. However, it may be advantageous to use some of these compounds in a deposit to provide various strength and performance characteristics. Furthermore, absence of the arc can enable the transfer of all, or nearly all, of the elements and compounds of the consumable that are otherwise volatile or sensitive to loss and difficult to transfer by arc welding.

In exemplary embodiments of the present invention, the cored consumables (1000/1100) do not have any arc initiators or arc stabilizers. As the consumables will not be used with an arc deposition process such components are not needed. The use of arc initiators and arc stabilizers in traditional cored consumables is often the result of a trade off between the need for these components and the potential adverse affects on the deposit. In fact, the hygroscopic nature of some of the components can result in increasing the deposit hydrogen content, which can be undesirable. Embodiments of the present invention need not make this trade off as these components are eliminated from the consumables. Specifically, any one, or a combination of, strontium, barium, lithium, sodium and potassium are used in arc process consumables to aid in arc initiation and arc stabilization. In fact, these elements can be used, in various combinations, in amounts up to 10 to 15% by weight of the consumable. Because embodiments of the present invention are not used in an arc deposition process these elements need not be present. Thus, in exemplary embodiments of the present invention, the cored-consumables 1000/1100 have a combined total of barium, potassium, lithium, strontium and sodium in the range of 0 to 0.02% by weight of the consumable. In further exemplary embodiments, the range is 0 to 0.01% by weight of the consumable. That is, in the consumables of the present invention no barium, potassium, lithium, strontium or sodium is intentionally added to the consumable. While there may be trace amounts of these elements, the trace amounts—if present—do not exceed the ranges provided herein. Because each of barium, lithium, strontium, sodium and potassium are used as arc stabilizers and initiators, their absence in the consumables of the present invention aid in preventing an arc from forming in any non-arc/hot-wire processes, thus contributing to the speed and efficiency of the hot-wire process.

It should be noted that throughout this application all percentages of elements are compounds are based on % by weight of the consumable, and not % by weight of the sheath (1010/1110) or the core (1030/1130). Furthermore, to the extent various elements and compounds are identified herein, embodiments of the present invention are not limited to their presence in either the sheath or the core. It may be beneficial to place many of the elements and compounds identified herein in the cores of consumables for ease of manufacture, but embodiments described herein are not so limited. That is, some of the compounds, alloys and elements described herein can also be added in the sheath.

In further exemplary embodiments of the present invention, carbonates are added to the consumables 1000/1100 to achieve a desired deposition chemistry. The use of carbonates in arc process consumables has been done sparingly, because of the reaction of carbonates in the arc. Typically, the total amount of carbonates present in cored consumables (for arc processes) is less than 3% by weight of the consumable. (It should be noted that this amount may be different in stick electrodes, which are not cored consumables as described herein.) However, in exemplary embodiments of the present invention, the utilization of carbonates can be increased above those known levels such that the consumables can provide a deposit with a desired chemistry. That is, in exemplary embodiments of the present invention the amount of carbonates present is in the range of 3 to 20% by weight of the consumable. In a further exemplary embodiment of the present invention, the amount of carbonates in the cored consumable is in the range of 5 to 15% by weight of the consumable. In embodiments, where it is desired to have more carbonates, the amount can be in the range of 10 to 20%. Such an amount of carbonates in a traditional cored arc process consumable could cause stabilization issues during deposition—especially due to the materials interacting with the arc. However, such levels of carbonates can be used with exemplary embodiments of the present invention. Exemplary embodiments of the present invention can use any one, or a combination of two or more, of the carbonates: calcium carbonate, magnesium carbonate, barium carbonate, lithium carbonate, strontium carbonate and iron carbonate. In other exemplary embodiments it may be desirable to add tungsten carbonate or lanthanum carbonates. Of course it should be noted that in any embodiment of the present invention which is to have a combined amount of sodium, potassium, lithium, strontium or barium in the range of 0 to 0.02% or 0 to 0.01%, none of sodium carbonate, potassium carbonate, barium carbonate, lithium carbonate or strontium carbonate can be used.

In an additional exemplary embodiment of the present invention, nitrides are added to the cored consumables 1000/1100. Like carbonates, traditional arc process consumables use limited amounts of nitrides because of their propensity to create nitrogen in the arc which can adversely affect the quality of the deposition or the deposition process, as is generally known. Typically, cored arc process consumables contain nitrides in an amount that is, collectively, less than 0.5% by weight of the consumable. Again, however, it may be desirable to have a level of nitrides in the deposit to achieve a desired chemistry. This cannot be done with arc process consumables, but can be done with consumables of the present invention. Specifically, embodiments of the present invention can have nitrides in the range of 0.5% to 25% by weight of the consumable. In further exemplary embodiments, the nitrides are in the range of 1 to 20% by weight of the consumable. In further exemplary embodiments the nitrides are in the range of 5 to 15% by weight of the consumable. It should be noted that to the extent a combination of nitrides are used the combination would be in the ranges specified above. Examples of nitrides that can be used with embodiments of the present invention include: titanium, boron, vanadium, tantalum, aluminum, and niobium. Carbonitrides can also be added to embodiments of the present invention and can include carbonitrides of B, Ti, V, Ta, Nb and Al.

The above exemplary embodiments can be used individually in a cored consumable for non-arc processes, or can be used in combination with each other to provide a cored consumable which has been optimized for a desired joining or overlaying operation.

In embodiments of the present invention that are used for overlaying or cladding operations the sheath 1010/1110 can be made from any one of an iron based, nickel based or cobalt based alloy and can have any number of alloying elements and compounds within the core 1030 or fill 1130 (depending on the embodiment). Examples, of alloying elements that can be found in either the core 1030 or the fill 1130 can include: C, Cr, Mo, Ni, Fe, Mn, Si, Al, N, Co, Nb, Ti, Ta, V, and Cu, among others. Examples of compounds that can also be present in the core 1030 or fill 1130 include, but are not limited to, carbides of W, Ti, Ti—Al, Cr, V, Nb, Co, Mo, and Ta. Depending on the intended application for a particular consumable, embodiments of the present invention can include carbides in the range of 10 to 50% by weight of the consumable. In applications where a large amount of carbides are needed, the carbides can be in the range of 30 to 50% by weight of the consumable, whereas in other applications where less carbides are needed, the carbides can be in the range of 10 to 30% by weight of the consumable. In some exemplary embodiments, the carbide % can be even higher than 50% and can be up to 80%, and can be in the range of 50 to 80%. In such embodiments, with high carbide fill percentages, the fill in the core will need to be particularly dense and the sheath will need to be relatively thin as compared to generally used sheaths. For example, one embodiment can use rhenium powder and a thin beryllium sheath to achieve such high carbide percentages. In some exemplary embodiments, a mixture of two or more of the above carbides can be used, at a desired ratio. However, in such embodiments, the above percentages should be generally maintained, depending on the embodiments.

Further exemplary embodiments can include compounds of borides, including borides of Ti, V, Nb and Ta. Additionally, embodiments can include sulfides of W and Mo.

The addition of carbides, borides, nitrides and/or carbonitrides can provide abrasion resistance to the cladding or overlaying deposit to increase its life in wear applications. However, the addition of sulfides can provide lubricity in metal-to-metal wear applications.

Cored consumables of the present invention used for overlaying/cladding operations can create a deposit having up to 70% any of the above carbides, borides, sulfides, and/or nitrides to provide the desired properties.

As stated previously, embodiments of the present invention can also be used for joining applications. In embodiments of the present invention that are used for joining applications the sheath 1010/1110 can also be made from any one of an iron based, nickel based or cobalt based alloy and can have any number of alloying elements and compounds within the core 1030 or fill 1130 (depending on the embodiment). Examples, of the compounds can include metal oxides such as TiO₂ and Al₂O₃. Embodiments of the present invention used for joining can also include carbides, such as TiAlC, TiC, NbC, Cr₃C₂, Cr₂₃C₆, and Cr₇C₃, which can be used singularly or in combination. The metal oxides and carbides can be used in either nanoparticle or larger grain sizes. When used as nanoparticles, the carbides can act as inoculants for grain refinement during joint solidification and transformation. Larger particles, having a nominal diameter in the range of 10 to 400 microns can act to provide abrasion and wear resistance in the deposit, and in some cases can act as dispersion strengtheners that increase the strength and toughness of the weld. In fact, in some exemplary embodiments, the particles can be even larger to provide a rough, wear resistant surface. For example, in some exemplary embodiments carbides particles can even be larger than 400 microns, but in such embodiments there may be space limitations in placing such particles in the core of the consumable. In some exemplary embodiments, a combination of nanoparticles and larger particles can be used. In some exemplary embodiments, the metal oxides and carbides are present in the cored-consumable to provide a weld deposit having up to 5% of the metal oxides and/or carbides.

When using exemplary embodiments of the present invention, a shielding gas may or may not be used, depending on the application. In some exemplary embodiments the shielding gas can be 100% argon, or any combination of argon/CO₂, argon/O₂, argon/N₂, and argon/He, or mixtures thereof, as needed.

It should be noted that the various embodiments of consumables as described herein can be utilized in any process in which the consumable is deposited into the puddle by direct contact with the puddle. For example, consumables as described herein can be used in any of a cold wire, hot wire, laser, laser-hot wire, GTAW-hot/cold wire and GMAW-hot/cold wire process. To the extent any of a GTAW or GMAW process is used the arc is used to create the puddle and not fully melt or transfer the consumable to the puddle.

It should also be noted that various combinations of the above exemplary embodiments are contemplated to create a consumable having desired performance characteristics and such combinations can be created without departing from the spirit or scope of the present invention. That is, various embodiments are contemplated using various combinations of attributes discussed above, including the absence of arc initiators and stabilizers, presence of carbonates, presence of nitrides, presence of carbides, borides, sulfides, particle size, etc., including the various ranges and amounts discussed herein.

Turning now to FIG. 2, FIG. 2 illustrates a functional schematic block diagram of an exemplary embodiment of a combination wire feeder and energy source system 100 for performing any of cladding, building up, filling, hard-facing overlaying, and joining/welding applications that can use consumables of the various embodiments described herein. The system 100 includes a laser subsystem capable of focusing a laser beam 110 onto a workpiece 115 to heat the workpiece 115. The laser subsystem is a high intensity energy source. The laser subsystem can be any type of high energy laser source, including but not limited to carbon dioxide, Nd:YAG, Yb-disk, Yb-fiber, fiber delivered or direct diode laser systems. Further, even white light or quartz laser type systems can be used if they have sufficient energy. Other embodiments of the system may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. The following specification will repeatedly refer to the laser system, beam and power supply, however, it should be understood that this reference is exemplary as any high intensity energy source may be used. For example, a high intensity energy source can provide at least 500 W/cm². The laser subsystem includes a laser device 120 and a laser power supply 130 operatively connected to each other. The laser power supply 130 provides power to operate the laser device 120.

The system 100 also includes a hot filler wire feeder subsystem capable of providing at least one cored consumable 140 to make contact with the workpiece 115 in the vicinity of the laser beam 110. Of course, it is understood that by reference to the workpiece 115 herein, the molten puddle is considered part of the workpiece 115, thus reference to contact with the workpiece 115 includes contact with the puddle. The hot filler wire feeder subsystem includes a wire feeder 150, a contact tube 160, and a hot wire power supply 170. During operation, the cored consumable 140, which leads the laser beam 110, is resistance-heated by electrical current from the hot wire welding power supply 170 which is operatively connected between the contact tube 160 and the workpiece 115. In accordance with an embodiment of the present invention, the hot wire welding power supply 170 is a direct current (DC) power supply, although alternating current (AC) or other types of power supplies are possible as well. The wire 140 is fed from the wire feeder 150 through the contact tube 160 toward the workpiece 115 and extends beyond the tube 160. The extension portion of the wire 140 is resistance-heated such that the extension portion approaches or reaches the melting point before or at contacting a weld puddle on the workpiece. The laser beam 110 serves to melt some of the base metal of the workpiece 115 to form a weld puddle and also to melt the wire 140 onto the workpiece 115. The power supply 170 provides a large portion of the energy needed to resistance-heat the cored consumable 140. The feeder subsystem may be capable of simultaneously providing one or more wires, in accordance with certain other embodiments of the present invention. For example, a first wire may be used for hard-facing and/or providing corrosion resistance to the workpiece, and a second wire may be used to add structure to the workpiece.

The system 100 further includes a motion control subsystem capable of moving the laser beam 110 (energy source) and the cored consumable 140 in a same direction 125 along the workpiece 115 (at least in a relative sense) such that the laser beam 110 and the cored consumable 140 remain in a fixed relation to each other. According to various embodiments, the relative motion between the workpiece 115 and the laser/wire combination may be achieved by actually moving the workpiece 115 or by moving the laser device 120 and the hot wire feeder subsystem. In FIG. 2, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the laser beam 110 and the wire 140 effectively travel along the workpiece 115. In accordance with an alternative embodiment of the present invention, the laser device 110 and the contact tube 160 may be integrated into a single head. The head may be moved along the workpiece 115 via a motion control subsystem operatively connected to the head.

In general, there are several methods that a high intensity energy source/hot wire may be moved relative to a workpiece. If the workpiece is round, for example, the high intensity energy source/hot wire may be stationary and the workpiece may be rotated under the high intensity energy source/hot wire. Alternatively, a robot arm or linear tractor may move parallel to the round workpiece and, as the workpiece is rotated, the high intensity energy source/hot wire may move continuously or index once per revolution to, for example, overlay the surface of the round workpiece. If the workpiece is flat or at least not round, the workpiece may be moved under the high intensity energy source/hot wire as shown if FIG. 2. However, a robot arm or linear tractor or even a beam-mounted carriage may be used to move a high intensity energy source/hot wire head relative to the workpiece.

The system 100 further includes a sensing and current control subsystem 195 which is operatively connected to the workpiece 115 and the contact tube 160 (i.e., effectively connected to the output of the hot wire power supply 170) and is capable of measuring a potential difference (i.e., a voltage V) between and a current (I) through the workpiece 115 and the hot wire 140. The sensing and current control subsystem 195 may further be capable of calculating a resistance value (R=V/I) and/or a power value (P=V*I) from the measured voltage and current. In general, when the hot wire 140 is in contact with the workpiece 115, the potential difference between the hot wire 140 and the workpiece 115 is zero volts or very nearly zero volts. As a result, the sensing and current control subsystem 195 is capable of sensing when the cored consumable 140 is in contact with the workpiece 115 and is operatively connected to the hot wire power supply 170 to be further capable of controlling the flow of current through the cored consumable 140 in response to the sensing, as is described in more detail within the application incorporated herein by reference, in its entirety. Specifically, the heating current is controlled such that there is no arc generated between the cored consumable 140 and the puddle and the current is controlled such that when an arc is detected, or when a threshold value (voltage, current and/or power) is reached the heating current is either shut off or modified such that no arc is generated. In accordance with another embodiment of the present invention, the sensing and current controller 195 may be an integral part of the hot wire power supply 170.

In accordance with an embodiment of the present invention, the motion controller 180 may further be operatively connected to the laser power supply 130 and/or the sensing and current controller 195. In this manner, the motion controller 180 and the laser power supply 130 may communicate with each other such that the laser power supply 130 knows when the workpiece 115 is moving and such that the motion controller 180 knows if the laser device 120 is active. Similarly, in this manner, the motion controller 180 and the sensing and current controller 195 may communicate with each other such that the sensing and current controller 195 knows when the workpiece 115 is moving and such that the motion controller 180 knows if the hot filler wire feeder subsystem is active. Such communications may be used to coordinate activities between the various subsystems of the system 100.

Of course, the above discussion is general in nature and the system 100 shown is a laser-hot wire system. Embodiments of the present invention are not limited to using the system 100 shown in FIG. 2, but can use other systems which deposit consumables without an arc. Examples of such other systems and their functions and configurations, as described in U.S. patent application Ser. No. 13/547,649, filed on Jul. 12, 2012, which is incorporated herein by reference in its entirety. Specifically, the present application incorporates the detailed discussions of the operation and structure of the hot-wire systems, and more specifically the methods and systems to control the heating current for the wire 140, disclosed in each of FIGS. 1-5, 11A-15, 17-18, and 20-27, such that no arc is formed between the wire and a puddle on the workpiece. Furthermore, processes as described above can utilize any contemplated embodiment of the cored consumable as described herein.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed.

What is claimed is:

1. A non-arc deposition process consumable, comprising:
a core; and
a metallic sheath surrounding said core,
wherein said consumable has a combined total of barium, potassium, lithium, sodium and strontium in the range of 0 to 0.02% by weight of the consumable.

2. The consumable of claim 1, wherein the combined total is in the range of 0 to 0.01%.

3. The consumable of claim 1, wherein said metallic sheath is made of one of an iron based alloy, nickel based alloy and cobalt based alloy.

4. The consumable of claim 1, further comprising a carbonate in the range of 3 to 20% by weight of the consumable.

5. The consumable of claim 4, wherein said carbonate is in the range of 5 to 15% by weight of the consumable.

6. The consumable of claim 4, wherein said carbonate is in the range of 10 to 20% by weight of the consumable.

7. The consumable of claim 4, wherein said carbonate is at least one of calcium carbonate, magnesium carbonate, iron carbonate, titanium carbonate and lanthanum carbonate.

8. The consumable of claim 1, further comprising a nitride in the range of 0.5 to 25% by weight of the consumable.

9. The consumable of claim 8, wherein said nitride is in the range of 1 to 20% by weight of the consumable.

10. The consumable of claim 8, wherein said nitride is in the range of 5 to 15% by weight of the consumable.

11. The consumable of claim 8, wherein said nitride is at least one of titanium, boron, vanadium, tantalum, aluminum and niobium nitrides.

12. The consumable of claim 1, further comprising a carbide.

13. The consumable of claim 12, wherein said carbide is in the range of 10 to 80% by weight of the consumable.

14. The consumable of claim 13, wherein said carbide is in the range of 10 to 30% by weight of the consumable.

15. The consumable of claim 13, wherein said carbide is in the range of 30 to 50% by weight of the consumable.

16. The consumable of claim 13, wherein said carbide is at least one of W, Ti, Ti—Al, Cr, V, Nb, Co, Mo and Ta.

17. The consumable of claim 1, further comprising at least one of a boride of Ti, V, Nb and Ta.

18. The consumable of claim 1, further comprising at least one of a sulfide of W and Mo.

19. The consumable of claim 13, wherein said carbide is at least one of TiAlC, TiC, NbC, Cr₃C₂, Cr₂₃C₆, and Cr₇C₃.

20. The consumable of claim 13, wherein at least some of said carbide has a nominal diameter in the range of 10 to 400 microns.

21. A non-arc deposition process consumable, comprising:
a core; and
a metallic sheath surrounding said core,
wherein said consumable comprises at least one carbonate and is present in the range of 3 to 20% by weight of the consumable.

22. The consumable of claim 21, wherein said consumable has a combined total of barium, potassium, lithium, sodium and strontium in the range of 0 to 0.02% by weight of the consumable.

23. The consumable of claim 21, wherein said consumable contains at least one nitride and said at least one nitride is present in the range of 0.5 to 25% by weight of the consumable.

24. The consumable of claim 22, wherein said consumable contains at least one nitride and said at least one nitride is present in the range of 0.5 to 25% by weight of the consumable.

25. The consumable of claim 21, further comprising at least one carbide in the range of 10 to 80% by weight of the consumable.

26. A non-arc deposition process consumable, comprising:
a core; and
a metallic sheath surrounding said core,
wherein said consumable contains at least one nitride and said at least one nitride is present in the range of 0.5 to 25% by weight of the consumable.

27. The consumable of claim 26, wherein said consumable comprises at least one carbonate and said at least one carbonate is in the range of 3 to 20% by weight of the consumable.

28. The consumable of claim 26, wherein said consumable has a combined total of barium, potassium, lithium, sodium and strontium in the range of 0 to 0.02% by weight of the consumable.

29. The consumable of claim 27, wherein said consumable has a combined total of barium, potassium, lithium, sodium and strontium in the range of 0 to 0.02% by weight of the consumable.

30. The consumable of claim 26, further comprising at least one carbide in the range of 10 to 80% by weight of the consumable.

31. A method of depositing a material, comprising:
creating a molten puddle with at least one high intensity energy source;
determining an upper threshold value;
directing at least one cored consumable to said molten puddle;
heating said at least one cored consumable with a heating signal from a power source to a temperature such that said cored consumable melts in said molten puddle when said cored consumable is in contact with said molten puddle;
maintaining contact between said cored consumable and said molten puddle during the depositing of said cored consumable;
monitoring a feedback from said heating signal;
turning off said heating signal when said upper threshold value is reached by said heating signal such that no arc is generated between said cored consumable and said molten puddle; and
turning on said heating signal to continue heating said cored consumable,
wherein said cored consumable, comprises:
a core; and
a metallic sheath surrounding said core,
wherein said cored consumable has a combined total of barium, potassium, lithium, sodium and strontium in the range of 0 to 0.02% by weight of the consumable.
